(19) United States
(12) Patent Application Publication
(10) Pub. No.: US 2026/0036493 A1
(43) Pub. Date: Feb. 5, 2026

(54) Method of monitoring a coating product line, and computer program product therefor

(71) Applicant: EXEL INDUSTRIES, EPERNAY (FR)

(72) Inventor: Thibault COGNON, EPERNAY (FR)

(21) Appl. No.: 19/283,238

(22) Filed: Jul. 29, 2025

(30) Foreign Application Priority Data
Aug. 5, 2024 (FR) 2408653

(51) Int. Cl. G01M 99/00; B05C 21/00; G01F 1/00

(52) U.S. Cl. CPC G01M 99/005; B05C 21/00; G01F 1/00

(57) ABSTRACT

A method of monitoring a coating product line, including equipment and a sensor. At least two equipment, so-called identifiable, are provided with an identification module able to communicate a respective identifier, the sensor being able to measure a parameter at an identifiable equipment, so-called base. The method includes reading the respective identifiers of the identifiable equipment, constructing a virtual model of the line from the read identifiers, receiving data measured by the sensor, and determining, from the measured data, data relative to an auxiliary equipment which is one of the identifiable equipment different from the base equipment.

### CROSS-REFERENCE TO RELATED APPLICATION

This application is a U.S. non-provisional application claiming the benefit of French Application No. 24 08653, filed on Aug. 5, 2024, which is incorporated herein by reference in its entirety.

### TECHNICAL FIELD OF THE INVENTION

This invention relates to a method of monitoring a coating product line, particularly of paint, the coating product line including a plurality of equipment.

The invention also relates to an associated computer program product.

### BACKGROUND OF THE INVENTION

Use of sensors on equipment to monitor operation of the equipment is known.

However, it is then necessary to provide each equipment of interest with the corresponding sensor to monitor the coating product line.

But the line with all the sensors is then particularly complex and expensive.

### SUMMARY OF THE INVENTION

The aim of the invention is then to propose a method of monitoring a coating product line that limits the complexity and cost associated with the line.

To this end, the invention has as its object a method of monitoring a coating product line, in particular paint, the coating product line includes a plurality of equipment and at least one sensor, wherein at least two equipment, so-called identifiable equipment, of the plurality of equipment are each provided with an identification module, each identification module includes a memory including a respective identifier, each identification module being able to communicate the respective identifier, the sensor being able to measure at least one parameter of the coating product line at one of the identifiable equipment, so-called base equipment, and in that the method includes:
providing an acquisition device including a reading module, able to read the respective identifiers of the respective identification modules,
reading by the acquisition device of the respective identifiers of the identifiable equipment of the coating product line,
constructing a virtual model of the coating product line from the read identifiers,
receiving data measured by the sensor, and
determining, from the measured data, determined data, the determined data being relative to at least one auxiliary equipment, the at least one auxiliary equipment being one of the identifiable equipment, different from the base equipment.

Thus, by means of a single sensor, information is obtained for a plurality of equipment. This allows monitoring the coating line without requiring a sensor for each equipment of interest.

According to other advantageous aspects of the invention, the method includes one or more of the following features, taken individually or according to any technically possible combination:
the base equipment is connected to the auxiliary equipment, the coating product line being devoid of branching between the base equipment and the auxiliary equipment, and, during determination, the determined data being considered equal to the measured data with a possible time lag;
the sensor is able to measure the quantity of coating product passing through the base equipment, the determined data includes the quantity of coating product passing through the auxiliary equipment, the method includes monitoring the cumulative quantity of coating product having passed through the auxiliary equipment from the determined data;
the method of monitoring includes emitting an alert signal when the cumulative quantity of coating product having passed through the auxiliary equipment exceeds a threshold;
each identification module includes a Near Field Communication tag;
the method of monitoring includes maintenance, using a maintenance kit, the maintenance kit being provided with an identification module with a respective identifier;
the method of monitoring includes:
replacing an identifiable equipment by a new equipment, the new equipment being provided with an identification module with a respective identifier,
reading the identifier of the new equipment by the acquisition device, and
replacing in the virtual model of the identifiable equipment with the new equipment.
the method of monitoring includes verifying the compliance of the determined data with at least one criterion of the auxiliary equipment, the criterion including, for example, a maximum value and/or a minimum value;
the method of monitoring includes:
providing at least one piece to be coated, the piece to be coated being provided with an identification module with a respective identifier, the coating product line being provided with a reader able to read the identifier of the piece to be coated by the coating product line,
detecting the identifier of the piece to be coated by the reader, and
determining the coating parameters of the piece to be coated from the measured data.

The invention also relates to a computer program product, including software instructions able to, when implemented by a computer, implement the construction, reception, and determination of a method of monitoring as described above.

### BRIEF DESCRIPTION OF THE DRAWINGS

The invention will become clearer upon reading the following description, given solely by way of non-limiting example, and made with reference to the drawings wherein:

FIG. 1 is a schematic representation of a system for the embodiment of the invention;

FIG. 2 is a schematic representation of a method according to a first embodiment of the invention; and

FIG. 3 is a schematic representation of a method according to a second embodiment of the invention.

### DETAILED DESCRIPTION

The invention relates to a method of monitoring a coating product line, particularly a paint line.

The coating product is, for example, fluid.

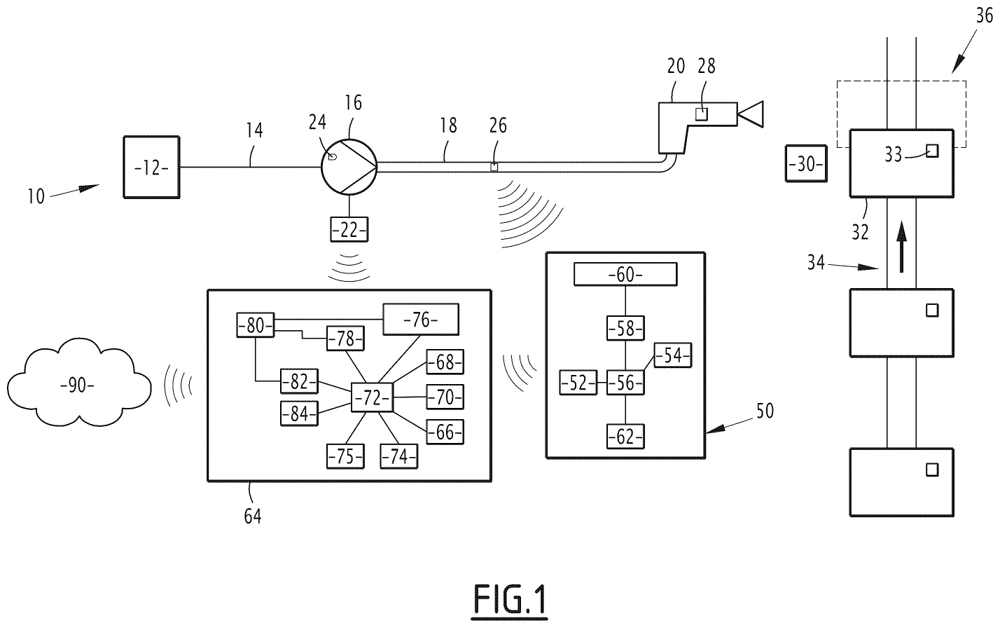

An example of a line 10 is represented in FIG. 1.

The line represented is a very simplified example, to illustrate a method of monitoring according to the invention. The line is not limited to the example provided. In particular, a coating product line generally includes a more complex system.

Line 10 includes a plurality of equipment 12, 14, 16, 18, 20 and at least one sensor 22.

More particularly, here, line 10 includes a power source 12, a pump 16, a supply path 14 extending between power source 12 and pump 16, an application device 20 of the coating product, and a distribution path 18 extending between pump 16 and application device 20.

The plurality of equipment 12, 14, 16, 18, 20 is, for example, arranged in line, in series.

At least two equipment, so-called identifiable equipment, 16, 18, 20 of the plurality of equipment, are each provided with an identification module 24, 26, 28.

Here, pump 16, distribution path 18, and application device 20 are each provided with an identification module 24, 26, 28.

Each identification module 24, 26, 28 is, for example, arranged within the corresponding identifiable equipment.

More particularly, each identification module 24, 26, 28 is not accessible from outside the identifiable equipment.

Alternatively, or additionally, each identification module 24, 26, 28 is fixed on the outside of the identifiable equipment.

Each identification module 24, 26, 28 includes a memory including a respective identifier. The respective identifier is specific to the identifiable equipment.

The respective identifier allows, for example, to identify the nature of the corresponding equipment.

Each identification module 24, 26, 28 is able to communicate with the respective identifier.

Each identification module 24, 26, 28 includes, for example, an RFID tag from the English “radio frequency identification” or, in French, radio-identification.

More particularly, each identification module 24, 26, 28 includes a Near Field Communication or NFC tag from the English “near-field communication”.

This allows remote detection of the desired tag.

The use of the NFC also allows the desired tag to be read in a safe and very selective manner, by approaching the corresponding equipment.

Each tag includes an antenna able to communicate and a memory storing the respective identifier.

Alternatively, one or each identification module 24, 26, 28 includes, for example, a visual identifier, for example, a QR code or an alphanumeric identifier, for example, the serial number of the identifiable equipment.

Sensor 22 is able to measure at least one parameter of line 10 at one identifiable equipment 16, 18, 20, so-called base equipment 16.

Sensor 22 is, for example, able to measure a quantity of coating product passing through base equipment 16, for example, a pump of line 10.

Sensor 22 includes, for example, a flow meter.

Sensor 22 is, for example, able to measure the pump strokes of the pump and calculate the quantity of coating product passing through the pump, here pump 16.

Additionally, or alternatively, sensor 22 measures pressure of coating product passing through base equipment 16.

At least one identifiable equipment 18, 20 is devoid of a sensor measuring the at least one parameter.

Base equipment 16 is connected to at least one auxiliary equipment 20, the auxiliary equipment 20 being one of identifiable equipment 16, 18, 20 different from base equipment 16.

Auxiliary equipment 20 is devoid of a sensor measuring the at least one parameter.

Line 10 is, for example, devoid of branching between base equipment 16 and auxiliary equipment 20.

Thus, all coating product passing through base equipment 16 passes, with a temporary delay, through auxiliary equipment 20.

In one particular embodiment, line 10 is provided with a reader 30 able to read a respective identifier of an identification module 33 of a piece to be coated 32 by the coating product line.

Reader 30 is, more particularly, able to read a respective identifier of a piece to be coated 32 arranged facing an application device 20 of line 10.

Reader 30 is, for example, arranged upstream of a coating location 36, where the piece to be coated is coated with the product of line 10, in a manner adjacent to coating location 36.

The pieces to be coated are, for example, successively brought by a line of pieces 34 to coating location 36.

Reader 30 is, for example, arranged facing the line of pieces 34, upstream of coating location 36, in a manner adjacent to coating location 36.

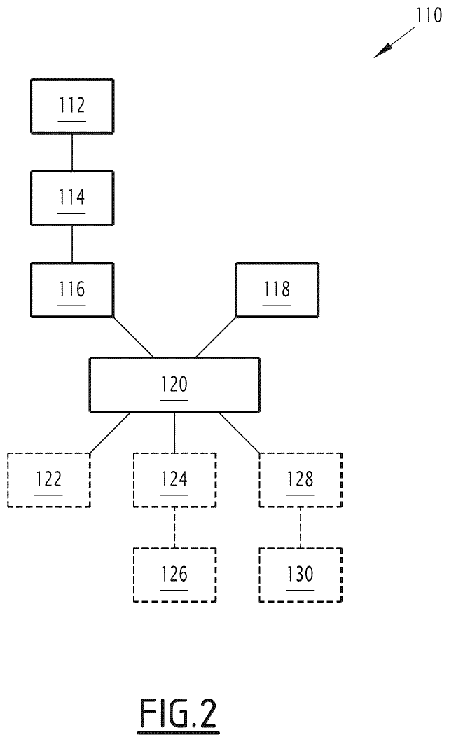

One example of an embodiment of a method of monitoring a coating product line will now be described with respect to FIG. 2, illustrated by the example of the system of FIG. 1.

The method of monitoring 110, includes:
providing 112 an acquisition device 50,
reading 114 by acquisition device 50 of the respective identifiers of the identifiable equipment of the coating product line,
constructing 116 a virtual model of the coating product line from the read identifiers,
receiving 118 data measured by the sensor, and
determining 120, from the measured data, determined data.

An example of an acquisition device 50, here an electronic device, is represented in FIG. 1.

Acquisition device 50 is, for example, a portable electronic device.

Acquisition device 50 incudes a reading module 52, able to read the respective identifiers of the respective identification modules.

Reading module 52 is, for example, an RFID reader, more particularly NFC.

Reading module 52 includes, for example, a radio frequency transceiver, able to send a request to an identification module, more particularly an RFID tag, here NFC, and receive, in response, the identifier of the identification module.

Acquisition device 50 also includes an information processing unit formed, for example, of a memory 54 and a processor 56 associated with memory 54.

Acquisition device 50 includes, for example, also an interface module 58 able to receive information from a user.

Acquisition device 50 includes here a user interface 60, for example, a touchscreen and/or buttons and/or a sound system.

User interface 60 includes, for example, a display device, here the touchscreen.

Interface module 58 is able to receive information provided by a user by means of user interface 60 and, for example, also to display elements on the display device and/or to emit a sound signal by the sound system.

Acquisition device 50 includes, for example, also a communication module 62.

Communication module 62 is, for example, able to allow communication between acquisition device 50 and an electronic device 64, for example, a computer, more particularly by telecommunication, for example, by Bluetooth®, or by wired connection, or by the mobile phone network.

Reading module 52, as well as an optional extra, interface module 58 and/or communication module 62, are each implemented as software, or embedded software, executable by processor 56. Memory 54 of electronic acquisition device 50 is then able to store the reading software, as well as an optional extra, the interface software and/or communication software. The processor is then able to execute each of the software from among the reading software, as well as an optional extra, the interface software and/or the communication software.

In one alternative, not represented, reading module 52, as well as an optional extra, interface module 58 and/or communication module 62, are each implemented as a programmable logic component, such as an FPGA (Field Programmable Gate Array), or an integrated circuit, such as an ASIC (Application Specific Integrated Circuit).

When the electronic acquisition device is implemented as one or more software, that is, as a computer program, also called a computer program product, it is also able to be recorded on a medium, not represented, readable by a computer. The readable medium is a non-transitory medium. The computer-readable medium is, for example, a medium able to store electronic instructions and to be coupled to a bus of a computer system. For example, the readable medium is an optical disk, a magneto-optical disk, a ROM memory, a RAM memory, any type of non-volatile memory (for example FLASH or NVRAM), or a magnetic card. A computer program, including software instructions, is then stored on the readable medium.

During reading 114, acquisition device 50 reads, for example, successively, all the respective identifiers of identifiable equipment 16, 18, 20 of line 10.

More particularly, a user successively moves acquisition device 50 closer to each identifiable equipment 16, 18, 20, so as to allow reading of the identifier of identification module 24, 26, 28 of each identifiable equipment 16, 18, 20.

Acquisition device 50 then stores the read identifiers in its memory 56.

When acquisition device 50 reads the identifier of an identification module 24, 26, 28, it emits, for example, a signal indicating to the user the detection, for example, a visual signal and/or a sound signal.

The user then understands that the identifiable equipment has been identified by the acquisition device and then moves toward another identifiable equipment until all the identifiable equipment has been identified.

In one particular embodiment, when acquisition device 50 reads the identifier of an identification module 24, 26, 28, acquisition device 50 displays on the display device one or more information relative to the corresponding identifiable equipment, for example, the nature of the identifiable equipment and/or the corresponding identifier.

In one embodiment, the display device displays the list of information of all the identifiable equipment the identifier of which has been read by the acquisition device.

Alternatively, only the information relative to the last identifiable equipment the identifier of which has been read is displayed.

In one particular embodiment, if several identifiable equipment are detected at the same time, then the read identifiers are all saved in memory 56. Alternatively, acquisition device 50 waits for a single identifiable equipment to be detected at a given time to save the read identifier.

In one particular embodiment, during the reading, the method includes receiving, by the acquisition device, data relative to the connection between identifiable equipment 16, 18, 20 the identifier of which is read.

More particularly, during the reading, a user provides, by means of user interface 60, information on the connection between identifiable equipment 16, 18, 20 the identifier of which is read.

The data relative to the connection between identifiable equipment 16, 18, 20 the identifier of which is read are saved in memory 54.

In the example represented, acquisition device 50 reads, for example, the identifier of pump 16, then that of distribution path 18. The user then indicates, for example, that distribution path 18 is connected in series to pump 16. Then acquisition device 50 reads the identifier of application device 20. The user then indicates that application device 20 is connected in series to distribution path 18, on the other side relative to pump 16.

Alternatively, the reading does not include receiving, by the acquisition device, data relative to the connection between the identifiable equipment the identifier of which is read.

Construction 116 is, for example, implemented by a construction module 66 of an electronic device 64, different from acquisition device 50.

Here, electronic device 64 includes construction module 66.

Electronic device 64 also includes a communication module 68 compatible with the communication technology of communication module 62 of acquisition device 50.

Electronic device 64 includes an information processing unit formed, for example, of a memory 70 and a processor 72 associated with memory 70.

The method then includes transmitting the read identifiers, and where applicable the data relative to the connection between identifiable equipment 16, 18, 20 the identifier of which is read, from acquisition device 50 to electronic device 64, by means of communication modules 62, 68.

During construction 116, a virtual model of line 10 is created from the read identifiers, and where applicable the data relative to the connection between identifiable equipment 16, 18, 20 the identifier of which is read.

In the absence of data relative to the connection between identifiable equipment 16, 18, 20 the identifier of which is read, the identifiable equipment of the line are, for example, considered as connected to each other, in series, more particularly without branching.

The virtual model of line 10 includes a representation of each identifiable equipment 16 and at least one link between the representations of the identifiable equipment.

The virtual model incudes, for example, mathematical links between elements each representing an identifiable equipment.

The virtual model of line 10 includes, for example, a table, each identifiable equipment corresponding to a column (alternatively a row), the columns (alternatively the rows) being linked together, for example, by mathematical links between cells of the columns (alternatively rows).

At least part of the cells represents, for example, a parameter relative to the corresponding identifiable equipment, for example, considered at a given time.

A row (alternatively a column) represents, for example, the same parameter for all the identifiable equipment.

For example, when two identifiable equipment are considered connected in line without branching, then it is, for example, considered that, in the virtual model, at least one cell of each of the columns (alternatively rows) corresponding to the elements are equal to each other, possibly with a temporary delay, more particularly equal to each other for the same row (alternatively column).

Additionally, or alternatively, when two identifiable equipment are considered connected in line without branching, then it is, for example, considered that, in the virtual model, at least one cell from each of the columns (alternatively rows) corresponding to the elements are equal to each other at a near predetermined coefficient, possibly with a temporary delay, more particularly equal to each other at the near predetermined coefficient for the same row (alternatively column).

The temporary delay corresponds here, for example, to the time for the flow of the coating product from upstream to downstream, between the base equipment and the auxiliary equipment.

Alternatively, the coating product line includes at least one Y-branch, including two inputs and one output. The line includes, for example, a base equipment on each of the inputs and an auxiliary equipment after the output. The mathematical link is then, for example, an addition, possibly with a temporary delay, and possibly to a near predetermined coefficient.

Alternatively, the coating product line includes at least one Y-branch, including one input and two outputs. The line includes, for example, a base equipment on at least two of the three paths formed by the input and the two outputs and an auxiliary equipment on the other path. The mathematical link is then, for example, an addition or a subtraction, possibly with a temporary delay, and possibly to a near predetermined coefficient.

The virtual model, here the table, is, for example, saved in memory 70.

Electronic device 64 also includes a reception module 74, reception module 74 being able to receive data from the at least one sensor 22, the data including the measurements of the at least one parameter measured by the at least one sensor 22.

During the reception of the measured data, at least part of the measurements acquired by sensor 22 are received, here by electronic device 64, here by reception module 74.

The measured data is then, for example, integrated into the table in the column (alternatively the row) corresponding to the identifiable equipment provided from sensor 22 having performed the measurement.

More particularly, the cells corresponding to the parameter corresponding to the measurements performed by sensor 22 are entered into the table.

During the determination, the determined data is calculated for the at least one auxiliary equipment from the measured data, for example, by a data determination module 75, more particularly of electronic device 64.

Here, for example, data is determined for the application device 20 from the data measured by sensor 22.

More particularly, by the links between the representations of the identifiable equipment, the determined data is calculated from the measured data.

For example, the determination includes filling the cells in the table corresponding to the auxiliary equipment from the cells corresponding to the base equipment, thanks to the mathematical links.

The determined data is, for example, equal to the measured data, with a possible temporary delay, particularly when the auxiliary equipment is connected in line with the base equipment without branching.

Alternatively, or additionally, considering only part of the determined data, the determined data is, for example, equal to the multiplication of the measured data by the predetermined coefficient, with a possible temporary delay.

Alternatively, the determined data is, for example, equal to an addition or subtraction of measured data, with a possible temporary delay, and possibly with a multiplication with a near predetermined coefficient, of different base equipment, particularly when the line presents at least one branch between the base equipment and the auxiliary equipment, each of the base equipment and the auxiliary equipment then being on a branch of the branch.

The determined data includes, for example, the quantity of coating product passing through the auxiliary equipment, more particularly the volumetric or alternatively mass flow rate.

Alternatively, or additionally, the determined data includes, for example, the pressure at the auxiliary equipment.

The method of monitoring also, optionally, includes displaying the determined data, and possibly the measured data, by a display device 76 of electronic device 64.

The method of monitoring also, optionally, incudes monitoring the cumulative quantity 124 of coating product having passed through the auxiliary equipment from the determined data, more particularly by a monitoring module 78, for example, included in electronic device 64.

This allows monitoring the use and wear of the auxiliary equipment.

The method of monitoring, then, also includes, for example, emitting an alert signal 126 when the cumulative quantity of coating product having passed through the auxiliary equipment exceeds a threshold, for example, by an alert module 80, here connected to monitoring module 78, for example, included in electronic device 64.

The alert signal is, for example, a visual signal, for example, an alert on display device 76, and/or sound.

This thus allows warning to plan for maintenance.

The alert signal indicates, for example, the maintenance to be performed, and for example, a type of maintenance kit to use depending on the equipment concerned and the maintenance.

The method of monitoring also optionally includes verifying 128 the compliance of determined data with at least one criterion of the auxiliary equipment, the criterion including, for example, a maximum value and/or a minimum value, for example, by a compliance module 82, for example, included in electronic device 64.

This allows to verify if the auxiliary equipment is used in accordance with its desired use, notably within recommended operating ranges.

The method of monitoring then also incudes, for example, emitting an alert signal 130 when the determined data does not comply to the criteria, for example, by alert module 80, here also connected to compliance module 82.

More particularly here, the determined data includes the pressure at the auxiliary equipment, the criterion being, for example, a maximum pressure not to be exceeded at the auxiliary equipment.

Alternatively, construction 116, and/or reception 118 and/or determination 120, and possibly display 122 and/or monitoring of cumulative quantity 124 and/or emitting an alert signal 126 and/or verification 128 and/or emitting an alert signal 130, are directly implemented by corresponding modules of acquisition device 50.

In one particular embodiment, the method of monitoring includes maintenance using a maintenance kit, the maintenance kit being provided with an identification module with a respective identifier.

The maintenance includes, for example, reading the identifier corresponding to the maintenance kit, for example, by acquisition device 50 or a similar acquisition device to acquisition device 50, more particularly the reading module 52.

The identifier notably allows to identify the type of maintenance kit.

The maintenance then includes, for example, emitting an alert if the maintenance kit does not correspond to the type of maintenance kit to perform the desired or indicated maintenance following an alert.

The method of monitoring includes, for example, transmitting the identifier of the maintenance kit to electronic device 64, more particularly by means of communication modules 62, 68, and storing the identifier of the maintenance kit in the memory 70.

This allows notably, to have a monitoring of the maintenance of the equipment of the coating product line.

This allows, for example, to verify that maintenance has been performed with an adequate and validated maintenance kit by the supplier of the coating product line.

In one particular embodiment, the method of monitoring includes:
replacing an identifiable equipment by a new equipment, the new equipment being provided with an identification module with a respective identifier,
reading the identifier of the new equipment by the acquisition device or an acquisition device similar to the acquisition device 50, more particularly by the reading module,
here, transmitting the identifier of the new equipment to the electronic device 64, more particularly by means of the communication modules 62, 68, and here storing the identifier of the new equipment in the memory 70, and
replacing in the virtual model of the identifiable equipment with the new equipment, more particularly by the construction module 66.

The method of monitoring includes, for example, emitting an alert when the new equipment is not a possible equipment for replacing the corresponding identifiable equipment.

This therefore allows to take into account the possible change of equipment in the coating product line, and for monitoring, in particular, the replaced equipment.

In monitoring cumulative quantity 124, if applicable, the cumulative quantity of coating product having passed through the auxiliary equipment is, for example, reset to zero following the replacement of the auxiliary equipment.

This also allows to verify that the replacements have been carried out with suitable and validated equipment by the supplier of the coating product line.

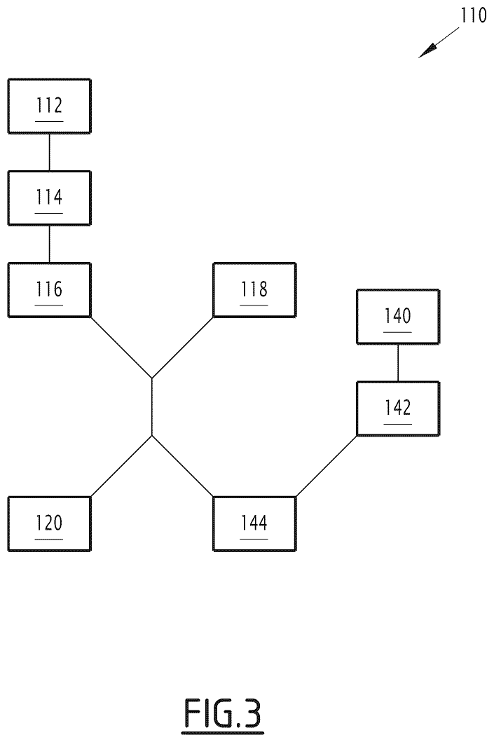

In one particular embodiment, represented in FIG. 3, the method of monitoring includes:
providing 140 at least one piece to be coated 32, the piece to be coated 32 being provided with an identification module 33 with a respective identifier,
detecting 142 a respective identifier by the reader 30,
here, transmitting the identifier by reader 30 to the electronic device 64, more particularly by means of communication module 68, and here storing the identifier in memory 70, and
determining coating parameters 144 of the piece to be coated 32 from the measured data, more particularly by a coating determination module 84, more particularly of electronic device 64.

Coating parameters 144 include, for example, a quantity of coating product applied to the piece to be coated and/or the flow rate of the coating product during the coating of the piece to be coated.

The determination is, for example, realized from the measured data during the duration corresponding to the coating interval of the piece, with a possible temporary delay, the temporary delay corresponding to the time interval for the flow of the coating product between the base equipment and its coating on piece to be coated 32.

The method includes, for example, emitting an alert if the coating parameters are not compliant to predetermined values, for example, by the alert module 80.

This allows, notably, to monitor the coating parameters with which the different pieces to be coated have been coated and to associate each piece with the corresponding parameters.

Furthermore, in case of an error in the coating identified later, this allows to quickly identify the pieces concerned by the error.

In one particular embodiment, the method of monitoring also includes saving the determined data, in particular in the “cloud” 90, more particularly of all the data present in memory 70.

Construction module 66, reception module 74, and data determination module 75, as well as an optional addition, communication module 58, monitoring module 78, alert module 80, compliance module 82, and/or coating determination module 84, are each realized as software, or embedded software, executable by the processor. The memory of electronic device 64 is then able to store construction software, data determination software, and reception software, as well as an optional addition, communication software, monitoring software, alert software, compliance verification software, and/or coating determination software. The processor is then able to execute each of the above software.

In one alternative, not represented, construction module 66, reception module 74, and data determination module 75, as well as an optional addition, communication module 58, monitoring module 78, alert module 80, compliance module 82, and/or coating determination module 84, are each realized as a programmable logic component, such as an FPGA (Field Programmable Gate Array), or an integrated circuit, such as an ASIC (Application Specific Integrated Circuit).

When electronic device 64 is realized as one or more software, in other words, as a computer program, also called a computer program product, it is also able to be recorded on a medium, not represented, readable by a computer. The computer-readable medium is, for example, a medium able to store electronic instructions and to be coupled to a bus of a computer system. The medium is a non-transitory medium. For example, the readable medium is an optical disk, a magneto-optical disk, a ROM memory, a RAM memory, any type of non-volatile memory (for example FLASH or NVRAM), or a magnetic card. On the readable medium is then stored a computer program including software instructions.

The invention also includes a computer program product, including software instructions able to, when implemented by a computer, implement the construction, reception, and determination of the method of monitoring described above.

1. A method of monitoring a coating product line, the coating product line comprising a plurality of equipment and at least one sensor, wherein at least two equipment, designated identifiable equipment, of the plurality of equipment are each provided with an identification module, each identification module comprising a memory comprising a respective identifier, each identification module communicating the respective identifier, the sensor measuring at least one parameter of the coating product line at one of the identifiable equipment, designated base equipment, the method comprising:
providing an acquisition device comprising a reading module that reads the respective identifiers of the respective identification modules;
reading by the acquisition device the respective identifiers of the identifiable equipment of the coating product line;
constructing a virtual model of the coating product line from the read identifiers;
receiving data measured by the sensor; and
determining, from the measured data, determined data relative to at least one auxiliary equipment, the at least one auxiliary equipment being one of the identifiable equipment different from the base equipment.

2. The method of monitoring according to claim 1, wherein the base equipment is connected to the auxiliary equipment, the coating product line being devoid of branching between the base equipment and the auxiliary equipment and wherein, during said determining, the determined data is considered equal to the measured data with a possible time lag.

3. The method of monitoring according to claim 1, wherein the sensor measures a quantity of coating product passing through the base equipment, and wherein the determined data comprises the quantity of coating product passing through the auxiliary equipment, the method further comprising monitoring the cumulative quantity of coating product having passed through the auxiliary equipment from the determined data.

4. The method of monitoring according to claim 3, further comprising emitting an alert signal when the cumulative quantity of coating product having passed through the auxiliary equipment exceeds a threshold.

5. The method of monitoring according to claim 1, wherein each identification module comprises a Near Field Communication tag.

6. The method of monitoring according to claim 1, further comprising maintaining using a maintenance kit, the maintenance kit comprising an identification module with a respective identifier.

7. The method of monitoring according to claim 1, comprising:
replacing an identifiable equipment with a new equipment, the new equipment being provided with an identification module with a respective identifier;
reading the identifier of the new equipment by the acquisition device; and
replacing in the virtual model the identifiable equipment with the new equipment.

8. The method of monitoring according to claim 1, further comprising verifying compliance of determined data with at least one criterion of the auxiliary equipment.

9. The method of monitoring according to claim 1, further comprising verifying compliance of determined data with at least one criterion of the auxiliary equipment comprising a maximum value and/or a minimum value.

10. The method of monitoring according to claim 1, further comprising:
providing at least one piece to be coated, the piece to be coated being provided with an identification module with a respective identifier, the coating product line being provided with a reader that reads the identifier of the piece to be coated by the coating product line;
detecting the identifier of the piece to be coated by the reader; and
determining coating parameters of the piece to be coated from the measured data.

11. A non-transitory computer program product comprising software instructions able to, when implemented by a computer, cause the computer to perform said constructing, said receiving, and said determining of the method of monitoring according to claim 1.
